(19) United States
(12) Patent Application Publication
(10) Pub. No.: US 2011/0048083 A1
(43) Pub. Date: Mar. 3, 2011

(54) LOCKING DEVICE

(76) Inventor: Douglas Adolph, Courtice (CA)

(21) Appl. No.: 12/549,141

(22) Filed: Aug. 27, 2009

(51) Int. Cl. E05B 73/00

(52) U.S. Cl. 70/58

(57) ABSTRACT

A locking device having two halves. An item may be secured in an interior of the two halves.

### FIELD OF THE INVENTION

This invention relates to locking devices and, more specifically, to a locking device for preventing access to an item such as a trailer hitch or an opening of a storage tank.

### BACKGROUND OF THE INVENTION

A locking device may be required on storage tanks in order to protect the contents in the storage tanks. The locking device may be used to prevent theft of the contents of the tank, to prevent the potential for vandalism via the introduction of foreign substances into the tank that may cause contamination of the contents of the tank or damage to the storage tank itself, or to prevent the potential for smuggling via placing contraband into the storage tank. Similarly, a locking device may be required on the tongue of a trailer coupling. The locking device would be used to prevent unauthorized use of the trailer hitch.

Presently, there are several different devices used for preventing access to a trailer coupling or an opening of a storage tank. One such device requires that it be permanently welded or otherwise coupled to the opening of a storage tank in place of a standard storage tank cap. However, installation of such a device may prove to be a costly or complicated process. Other devices may be more easily installed, but fail to provide adequate protection. These devices may be more easily pried from the tank when compared to devices that are welded to the tank.

Therefore, a need existed to provide a locking device to overcome the above problems. The locking device would provide a secure and convenient way of preventing access to items including a variety of different forms of storage tank caps or trailer couplings.

### SUMMARY OF THE INVENTION

A device for preventing access to an item, such as a cap of a storage tank or a trailer coupling, has a pair of semicylindrical objects. The semicylindrical objects have a hollow interior, and can be securely coupled about a storage tank cap or a trailer coupling, thereby preventing either the removal of the storage tank cap or the coupling of a trailer to the trailer hitch.

The present invention is best understood by reference to the following detailed description when read in conjunction with the accompanying drawings.

### BRIEF DESCRIPTION OF THE DRAWINGS

FIG. 1 is a perspective view of one embodiment of the locking device, the locking device shown in an open position;

FIG. 2 is a perspective view of the locking device with an additional anti-tampering device, the locking device shown in an open position;

FIG. 3 is a perspective view of the embodiment shown in FIG. 2, the locking device shown in a closed position;

FIG. 4 is a bottom perspective view of the locking device shown in FIGS. 2 and 3, the locking device shown in a closed position;

FIG. 5 is a cross-sectional view of another embodiment of the locking device taken along perspective lines 5-5 (shown in FIG. 6), the locking device shown in an open position;

FIG. 6 is a perspective view of the embodiment shown in FIG. 5;

FIG. 7 is a cross-sectional view of another embodiment of the locking device taken along perspective lines 7-7 (shown in FIG. 8), the locking device shown in an open position;

FIG. 8 is a perspective view of the embodiment shown in FIG. 7;

FIG. 9 is a perspective view of another embodiment of the locking device, the device shown in an open position; and

FIG. 10 is a perspective view of the locking device of FIG. 2-4 in use, the locking device being placed around a filler neck of a storage tank.

Common reference numerals are used throughout the drawings and detailed description to indicate like elements.

### DETAILED DESCRIPTION

One reliable way to prevent access to an item, such as a storage tank opening, or a the trailer coupling, is to place a locking device comprising two halves and made of a durable material at least partially about the item, a cap of the storage tank, or a trailer coupling.

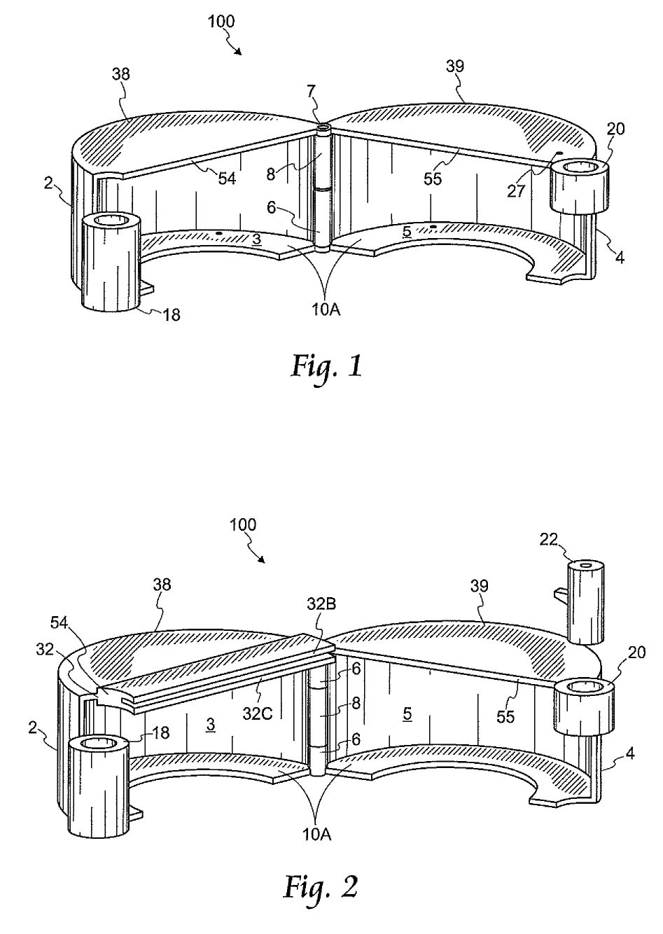

Referring now to FIG. 1, an embodiment of a locking device 100a is shown. The locking device 100a may have a first half 2 and a second half 4. The first half 2 and the second half 4 may take on different shapes. In accordance with the present embodiment, the first half 2 and the second half 4 are each generally of the shape of a semicylinder. Each half 2 and 4 may have a hollow interior 3 and 5. Each half 2 and 4 may also have a bottom surface 12. The bottom surface 12 may form a collar 10a. The collar 10a may be an annular member when the first half 2 is secured to the second half 4. The collar 10a may also comprise two segments that remain separate when the first half 2 is secured to the second half 4, as will be discussed below. It should be understood that the locking device 100a may have two halves 2 and 4 of unequal size, and/or may have two halves 2 and 4 that are of a non-semicylindrical shape, without departing from the scope and spirit of the present invention. It should further be understood that the locking device 100a may have a differently formed bottom surface 12, or may have a differently formed collar 10a, or may even lack any collar 10a.

The first and second halves 2 and 4 maybe coupled together. In accordance with one embodiment, the first and second halves 2 and 4 may be hingably coupled together. The first and second halves 2 and 4 may be coupled together at one end by a first portion of a hinge 6 coupled to the first half 2 and a second portion of a hinge 8 coupled to the second half 4 with a pin 7 passing through the first and second portions of the hinge 6 and 8. However, it should be clearly understood that the first and second halves 2 and 4 may be coupled to one another by means other than a hinge 6 and 8 and pin 7 without departing from the scope and spirit of the present invention.

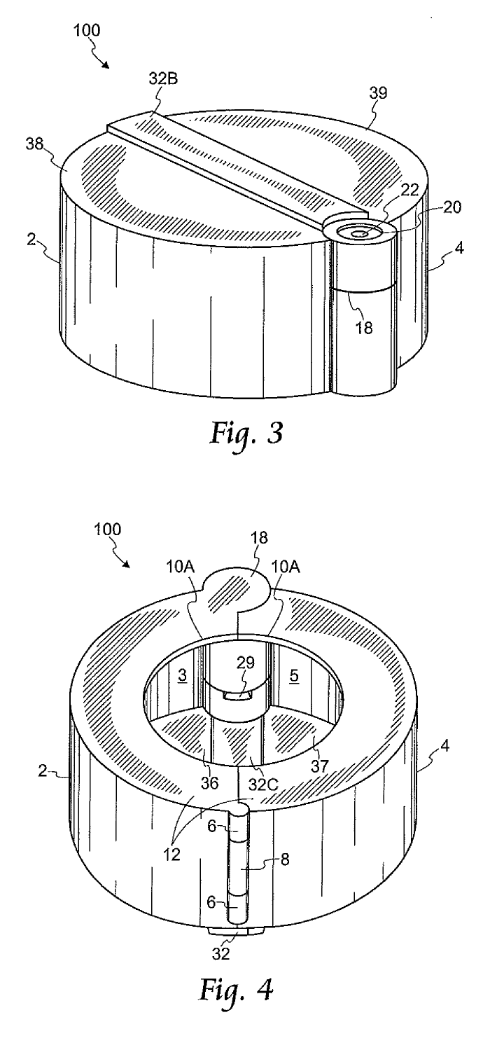

In the present embodiment, the first and second halves 2 and 4 may be secured together. The first and second halves 2 and 4 may be secured together by a securing mechanism. The securing mechanism may be a first locking channel 18 coupled to the first half 2 and a second locking channel 20 coupled to the second half 4. The locking channels 18 and 20 may align when the first and second halves 2 and 4 are brought together. A locking mechanism 22 (shown in FIGS. 2, 3, and 10) may be disposed within the locking channels 18 and 20 when they are aligned. One of the locking channels 18 and 20 may have a locking member aperture 29 (shown in FIG. 4). The locking member aperture 29 may house a portion of the locking mechanism 22. The locking member aperture 29 may house a portion of the locking mechanism 22 in order to prevent its removal when locked. It should be understood that the first and second halves 2 and 4 may be secured by means other than the locking channels 18 and 20, such as by the use of a sufficiently powerful electromagnet, and that other types of locking mechanisms 22 may be passed through locking channels 18 and 20 in lieu of the specific type of locking mechanism 22 shown, and/or absent any locking member aperture 29, without departing from the scope and spirit of the present invention.

Referring now to FIGS. 2-4, another embodiment of the locking device 100b is shown. In addition to the features of the embodiment of the locking device 100a shown in FIG. 1, the two halves 2 and 4 may have a tamper-resistant device 32. The tamper-resistant device 32 may prevent insertion of an object that might be used to pry the two halves 2 and 4 apart. The tamper-resistant device 32 may be coupled to one of the halves 2 and 4. In the present embodiment, the tamper-resistant device 32 may be coupled to the top surface 38 of the first half 2. The tamper-resistant device may also run a majority of the length 54 of the top surface 38, although it should be understood that the tamper-resistant device 32 may run a majority of the length 54 or 55 of either of the top surfaces 38 or 39 of one of the halves 2 or 4. The tamper-resistant device 32 may also run less than a majority of the length 54 or 55 to which it is coupled, as will be discussed below. Furthermore, it should be noted that the tamper-resistant device 32 may be coupled to a different portion of the locking device 100b without departing from the scope and spirit of the present invention. The tamper-resistant device 32 may comprise two members 32b and 32c with a space there between, and may partially house a majority of the length 55 of the opposing second half 4. It should be understood that the locking device 100b may have a differently formed and/or differently oriented tamper-resistant device 32, or may even lack a tamper-resistant device 32, without departing from the scope and spirit of the present invention.

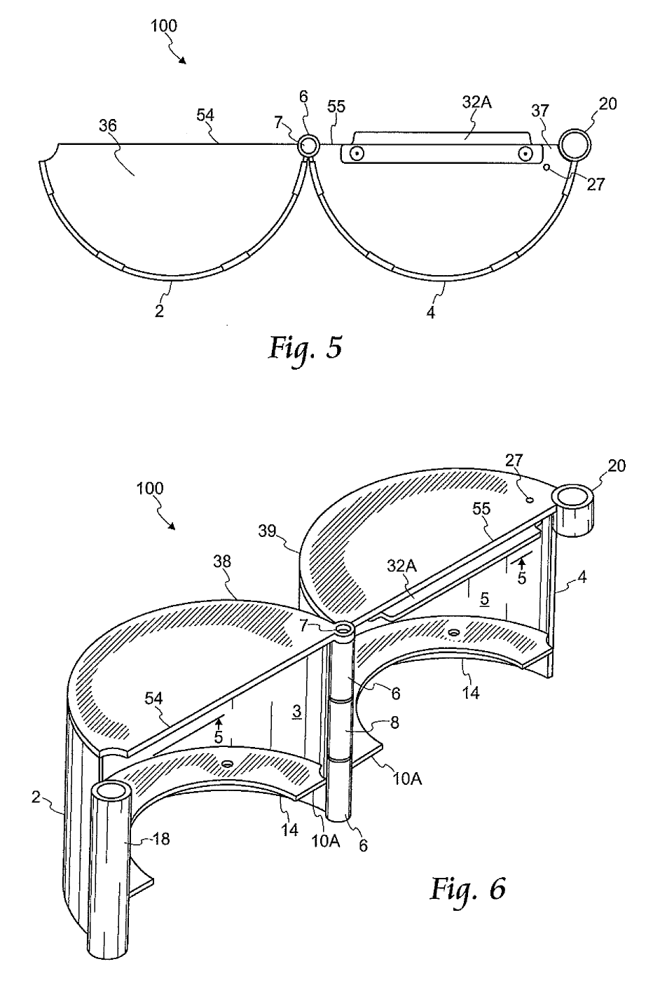

For example, and now referring to FIGS. 5 and 6, another embodiment of the locking device 100c is shown. The tamper-resistant device 32a may be a single member coupled to a top surface 39 of the second half 4. The tamper-resistant device 32a may be coupled to an underside 37 of the top surface 39 of the second half 4. The tamper-resistant device 32a may rest proximate an underside 36 of the opposing first half 2 when bringing the two halves 2 and 4 together. Further, the tamper-resistant device 32a may pass under the first locking channel 18. This tamper-resistant device 32a may serve the same function as the tamper-resistant device 32 of the locking device 100b shown in FIGS. 2-4 to prevent the two halves 2 and 4 from being pried apart.

In addition to the tamper resistant device 32a and the features of the embodiment of the locking device 100a shown in FIG. 1a, the present embodiment of the locking device 100c may have halves 2 and 4 that may have extended walls 14. The extended walls 14 may extend past the collar 10 formed in the bottom surface 12, as shown in FIG. 6. If this embodiment of the locking device 100c is used with a storage tank 44 having an extended filler neck 42, the extended walls 14 may provide additional protection of the filler neck 42 (shown in FIG. 10). The extended walls 14 may thereby provide additional protection of the contents of the storage tank 44 (shown in FIG. 10). However, it should be understood that locking device 100c may lack extended walls 14 that extend past the bottom surface 12, without departing from the scope and spirit of the present invention.

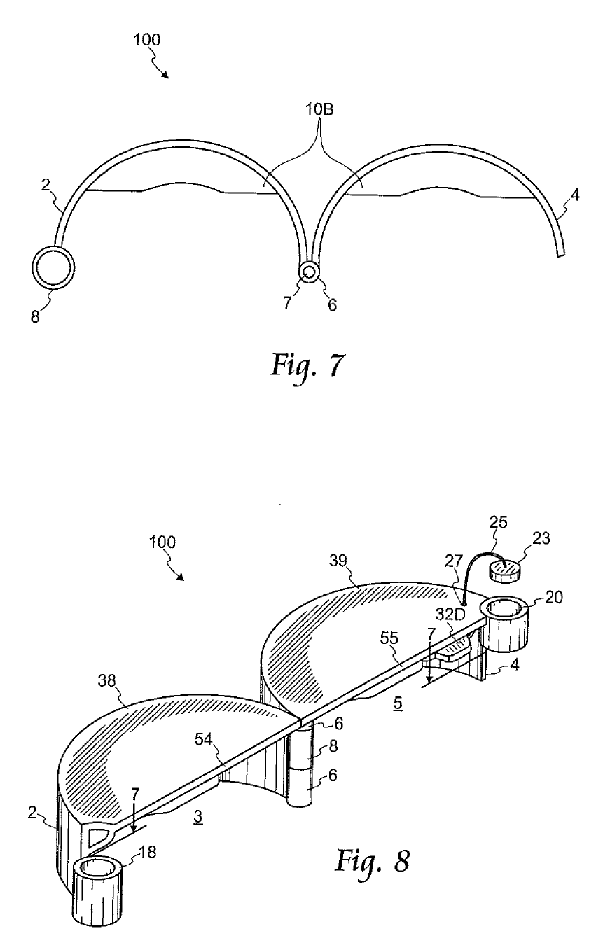

Referring now to FIGS. 7 and 8, another embodiment of the locking device 100d is shown. In addition to the features of the embodiment of the locking device 100a shown in FIG. 1, the present embodiment may have a tamper-resistant device 32d that may run a lesser portion of the length 55 of the top surface 39 of the second half 4. This tamper-resistant device 32a may serve the same function as the tamper-resistant device 32 of the locking device 100b shown in FIGS. 2-4.

Additionally, the locking device 100d of the present embodiment may have a collar 10b. The collar 10b may comprise two segments. The two segments may remain separate when the first half 2 is secured to the second half 4, as opposed to the collar 10a of FIG. 1.

The locking device 100d of the present embodiment may also have a channel cap 23. The channel cap 23 may be placed over the locking channels 18 and 20. By placing the channel cap 23 into the locking channels 18 and 20, the channel cap 23 may protect the locking mechanism 22 from weather. The channel cap 23 may be tethered to a portion of the locking device 100d. The channel cap 23 may be tethered to the locking device 100d by a leash 25. The leash 25 may be attached to a portion of the locking device 100d. The leash 25 may be attached to the locking device 100d by passing a portion of the leash 25 through an aperture 27 in a portion of the locking device 100d. The aperture 27 may be defined by one of the top surfaces 38 and 39 of the locking device 100d, although the aperture 27 may be defined by another surface. It should be understood that a channel cap 23 may be used with another embodiment of the locking device 100a, 100b, 100c, or 100e. It should also be understood that a channel cap 23 may be provided in the absence of being tethered to a portion of the device 100d, or may be attached to the device 100d through means other than a leash 25, or may be not provided at all, without departing from the scope and spirit of the present invention.

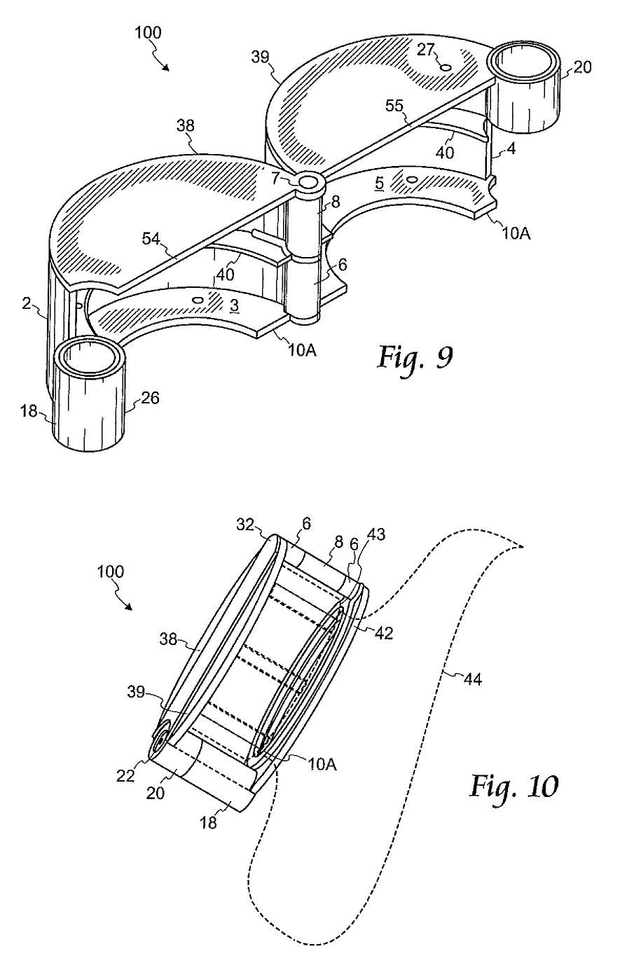

Referring now to FIG. 9, an additional embodiment of the locking device 100e is shown. In addition to the features of the embodiment of the locking device 100a shown in FIG. 1, each half 2 and 4 may additionally have an interior collar 40. Similar to the bottom collar 10b of the locking device 100d shown in FIG. 7, the interior collar 40 may comprise two segments. The interior collar 40 may be an annular member when the first and second halves 2 and 4 are brought together. The two segments may also remain separate when the first half 2 is secured to the second half 4, similar to the collar 10b of FIG. 7. The interior collar 40 may serve to create a snug fit about the circumference of a storage tank cap 43, although this is only given as an example, and should not be seen to limit the scope of the present invention.

Referring now to FIGS. 10 and 11, the locking device 100b may be positioned about an item. Positioning the locking device 100b about an item may prevent access to that item. The item may be a storage tank cap 43, as shown in FIG. 10, or a trailer coupling. The locking device 100b may prevent access to item 43 or a trailer coupling by placing the storage tank cap 43 or a trailer coupling partially within the hollow interior 3 of the first half 2 and then coupling the second half 4 to the first half 4. The storage tank cap 43 or a trailer coupling may be partially within the hollow interiors 3 and 5 of the two halves 2 and 4 by causing the storage tank cap 43 or a majority of a trailer coupling to be contained within the hollow interiors 3 and 5 of the first and second halves 2 and 4 between the collar 10a and the top surfaces 38 and 39. In order to ensure that storage tank cap 43 or a trailer coupling is not removed from the hollow interiors 3 and 5 of the first and second halves 2 and 4 while still allowing the storage tank cap 43 to remain attached to a storage tank 44 or a trailer coupling to be rendered inoperable, either the storage tank cap 43 or a trailer coupling may be disposed between the bottom surface 12 and the top surfaces 38 and 39 of the first and second halves 2 and 4. Furthermore, the filler neck 42 of the storage tank 44 or the tongue of a trailer coupling may pass through the collar 10a formed by the bottom surface 12. However, it should be understood that different items may be secured within the locking device 100b, and that different embodiments of the locking device 100a, 100c, 100d, and 100e may be used, without departing from the scope and spirit of the present invention.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

1. A lock comprising:
a first half comprising a hollow interior;
a second half comprising a hollow interior and rotatably coupled to the first half, wherein the first half is secured to the second half to prevent access to an item housed within the lock;
a first tube coupled to the first half;
a second tube coupled to the second half and axially aligned with the first tube; a pin passing through the first and second tubes to hingly secure the first half to the second half;
a securing device for preventing unauthorized separation of the first and second halves, wherein the securing device comprises:
a first channel coupled to the first half; and
a second channel coupled to the second half, the first and second channels being aligned when the first half is secured to the second half;
a locking mechanism passing through the first and second channels and located completely within the first and second channels, wherein an interior surface of at least one of the first channel or second channel has a locking member aperture for securing the locking mechanism;
a cover coupled to the lock for covering at least one of the first or second channels to prevent damage to the locking mechanism when the locking mechanism is located completely within the first and second channels; and
a tampering mechanism coupled to one of the first and second halves for preventing insertion of a device between the first and second halves, wherein the tampering mechanism comprises:
a first end coupled to an underside of a top surface of one of the first and second halves; and
a second end proximate an underside of a top surface of an opposing half when the first half is secured to the second half.

2. (canceled)

3. The lock of claim 1 further comprising a collar formed on a bottom surface of the first and second halves.

4. The lock of claim 3 wherein a length of the first and second halves extending below the collar.

5. The lock of claim 3 further comprising a rubber coating applied to the bottom surface of the first and second halves.

6. (canceled)

7. (canceled)

8. (canceled)

9. (canceled)

10. (canceled)

11. The lock of claim 1 wherein the cover is coupled to the lock by a leash.

12. (canceled)

13. (canceled)

14. The lock of claim 1 further comprising an interior collar disposed in the hollow interiors of the first and second halves.

15. A lock comprising:
a first half comprising a hollow interior;
a second half comprising a hollow interior and hingably coupled to the first half, wherein the first half is secured to the second half to prevent access to an item housed within the lock;
a collar formed on a bottom surface of the first and second halves;
an interior collar disposed in the hollow interiors of the first and second halves;
a securing device for preventing unauthorized separation of the first and second halves; and
a tampering mechanism coupled to one of the first and second halves for preventing insertion of a device between the first and second halves.

16. The lock of claim 15 wherein the securing device comprises:
a first channel coupled to the first half; and
a second channel coupled to the second half, the first and second channels being aligned when the first half is secured to the second half.

17. The lock of claim 16 further comprising a locking mechanism passing through the first and second channels, and wherein an interior surface of at least one of the first and second channels has a locking member aperture for securing the locking mechanism.

18. The lock of claim 16 further comprising:
a leash coupled to a portion of the lock; and
a cover coupled to the leash for covering at least one of the first or second channels.

19. (canceled)

20. A lock comprising:
a first half comprising a hollow interior;
a second half comprising a hollow interior and hingly coupled to the first half, wherein the first half is secured to the second half to prevent access to an item housed within the lock;
a collar formed on a bottom surface of the first and second halves;
a securing device for preventing unauthorized separation of the first and second halves comprising:
a first channel coupled to the first half; and
a second channel coupled to the second half, the first and second channels being aligned when the first half is secured to the second half;
an amount of rubber coating adhered to the bottom surface of the first and second halves;
a locking mechanism passing through the first and second channels, wherein an interior surface of at least one of the first and second channels has a locking member aperture for securing the locking mechanism;
a leash coupled to a portion of the lock;
a cover coupled to the leash for covering at least one of the first or second channels;
a tampering mechanism coupled at a first end to one of the first and second halves for preventing insertion of a device between the first and second halves when the first half is secured to the second half; and
an interior collar disposed in the hollow interiors of the first and second halves.
